(19) United States
(12) Patent Application Publication
(10) Pub. No.: US 2019/0000107 A1
(43) Pub. Date: Jan. 3, 2019

(54) METHOD AND APPARATUS FOR PRODUCING A BEVERAGE IN A BEVERAGE CONTAINER, AND BEVERAGE ARTICLE

(71) Applicant: KUKKI GmbH, Berlin (DE)

(72) Inventors: Josef KLEMM, Berlin (DE); Saif HAMED, Berlin (DE)

(73) Assignee: KUKKI GmbH, Berlin (DE)

(21) Appl. No.: 16/063,918

(22) PCT Filed: Apr. 8, 2016
(86) PCT No.: PCT/DE2016/100165

§ 371 Date: Jun. 19, 2018

(30) Foreign Application Priority Data
Dec. 22, 2015 (DE) 10 2015 122 610.3

(51) Int. Cl. A23G 9/04; F25C 5/20

(52) U.S. Cl. CPC A23G 9/045; A23G 9/52; F25C 5/20

(57) ABSTRACT

A method for producing a beverage in a beverage container, having the following steps: providing a beverage container which is to be filled; introducing a cooling agent to the beverage container through a container opening, wherein the cooling agent has at least one water-ice moulding; filling the beverage container with a beverage liquid through the container opening; closing the container opening with a disposable closure and storing the filled beverage container in a cooled environment. The disclosure also covers an apparatus for producing a beverage in a beverage container, as well as a beverage article containing a beverage.

The invention relates to a method and an apparatus for producing a beverage in a beverage container and a beverage article comprising a beverage.

### BACKGROUND

Currently, beverages are only bottled in liquid form and, if applicable, are frozen solid as a whole by means of external cooling. The addition of ice cubes does not take place during the bottling into the transport vessel, but only later, when the beverage is refilled into a serving vessel.

Due to space problems (train restaurants) or due to a lack of electrical power supply (beach bars), it is frequently not possible to operate cooling devices to store the ice cubes therein at the location of serving or of consumption, respectively.

A beverage is then frequently consumed simply without ice cubes at such locations, which, however, negatively impacts enjoyment and taste. Cocktails need ice in particular.

### SUMMARY

It is the object of the invention to specify new technologies, which provide for expanded forms of presentation for alcoholic and non-alcoholic beverages. In particular, a method for producing a beverage in a beverage container and a beverage article comprising a beverage is to be created.

The object is solved by means of a method and an apparatus for producing a beverage in a beverage container according to claims 1 and 12. A beverage article comprising a beverage according to claim 13 is also created. Alternative embodiments are the subject matter of dependent claims.

According to one aspect, a method for producing a beverage in a beverage container is created. It has the following steps: providing a beverage container, which is to be filled; introducing a cooling agent in the beverage container through a container opening, wherein the cooling agent has at least one water ice molding; filling the beverage container with a beverage liquid through the container opening; closing the container opening by means of a disposable closure; and cooled storing of the filled beverage container.

According to a further aspect, an apparatus for producing a beverage in a beverage container is created. The apparatus is set up: to provide a beverage container, which is to be filled; to introduce a cooling agent in the beverage container through a container opening via an inserting apparatus, wherein the cooling agent has at least one water ice molding and wherein the inserting apparatus is formed with a guide device and a positioning device, by means of which an outlet of the guide device is positioned relative to the container opening; to fill the beverage container with a beverage liquid through the container opening; and to close the container opening by means of a disposable closure.

According to a further aspect, a beverage article comprising a beverage is created. The beverage article has a beverage container, which is filled with a beverage liquid. A cooling agent, which has at least one water ice molding and is accommodated in the beverage liquid, is furthermore introduced in the beverage container. A container opening of the beverage container is closed by means of a disposable closure, through which the cooling agent comprising the at least one water ice molding and the beverage liquid are introduced in the beverage container.

After the opening, the disposable closure can be capable of being closed again. Alternatively, provision can be made for an embodiment of the disposable closure, wherein a reclosing is not made possible, for example as a result of a destruction of the disposable closure during the first-time opening. The term disposable closure in the meaning used herein also comprises closures, which can be reclosed repeatedly, whereby a freshness or closure seal can be destroyed during the first-time opening after a filling process. This can be, for example, a clip, screw or plug closure, which, after the filling of the beverage container, is provided with a seal, which tears open during the first-time opening, and which is destroyed in this way, for example a paper seal.

The beverage container can be a disposable or a reusable container, for example a disposable or a reusable bottle.

The cooling agent can be introduced with the at least one water ice molding, which can also be identified in short as ice molding, during and/or after the filling of the beverage container with the beverage liquid.

The filled beverage container can be stored at a cooling temperature that is higher than the freezing point of the beverage liquid. However, a partial freezing of the beverage liquid, optionally to freezing solidly, can be provided in the context of the cooled storage.

The container opening can be closed by means of a disposable closure from the following group: crown cork, cork, screw closure, twist-off closure, clip closure, hot sealing closures.

The beverage container can have a container section, which tapers towards the container opening, and the cooling agent comprising the at least one water ice molding and the beverage liquid can be introduced through the tapering container section after passing the container opening. It can be a beverage bottle, in the case of which the tapering section is formed with a bottle neck.

The at least one water ice molding can in one spatial dimension be larger than a diameter of the container opening.

An alcoholic beverage liquid, which includes a percentage of ethanol, and/or a non-alcoholic beverage liquid, which includes a percentage of glycerin, can be filled in.

Prior to introducing the cooling agent and/or prior to filling with the beverage liquid, the beverage container can be cooled to a temperature between the freezing point of the beverage liquid and 0° C.

When introducing the cooling agent comprising the at least one water ice molding, an amount of liquid water, which covers the one vessel bottom of the beverage container, can additionally be filled into the beverage container.

During the cooled storage, the filled beverage container can be cooled to a cooling temperature which is lower than a melting temperature of the beverage liquid.

The at least one water ice molding can be supplied to the container opening via a guide device, wherein the guide device is positioned relative to the container opening by means of a positioning device. The positioning device can hereby be brought into direct with the beverage container, can for example support itself thereon, for example in the area of the container opening and/or the tapered container section. The positioning device can partially or completely encompass the container opening. The guide device for the ice moldings has an end-side outlet, which is oriented towards the container opening by means of the positioning device. The apparatus for introducing with the guide device and the positioning device can be used in the case of the method described herein or, alternatively, also in the case of other methods, which provide for the insertion of an ice molding.

Further alternative embodiments will be described below.

The following can be provided when filling the beverage container. At first, at least one water ice molding can be added into the beverage container, liquid beverage liquid with a freezing point G of lower than 0° C. is then added into the beverage container in order to then close the beverage container by means of the disposal closure, and the beverage is then stored so as to be cooled at a temperature T with G<T≤0° C. Alternatively, the liquid beverage liquid is initially added into the beverage container with a freezing point G of lower than 0 degrees Celsius, at least one water ice molding is then added into the beverage container, and the beverage is stored at a temperature T with G<T≤0° C. after the closing of the beverage container.

The beverage container or the vessel is a vessel that is suitable for the storage and the transport of beverages so as to be cooled below 0° C.

The ice moldings can be frozen water, thus water ice which had been brought into a shape in response to the production. The shape can be arbitrary. Its nature, however, is such that the ice moldings can be introduced through the opening of the beverage container. The ice moldings can for example have the shape of elongated cylinders or cones or of cubes.

The beverage liquid is for example an alcoholic or non-alcoholic water-based drinkable liquid, for example a cocktail mixture with different juices and/or alcoholic substances. The alcoholic substances effect a lowering the melting point (freezing point of the beverage liquid) to below 0° C. In the case of the non-alcoholic beverage, the latter contains an antifreeze agent, for example glycerin. It can be influenced via the sequence in response to the bottling process, whether the ice cubes swim loosely in the beverage liquid in the completely filled beverage container later or whether they are secured to the bottom so as to be frozen thereto.

In the beverage liquid, alcohol can at least be formed by ethanol and/or glycerin. Colloquially, a differentiation is often made between cocktails with and without alcohol. In principle, the cocktails “with alcohol” contain ethanol, which has an intoxicating effect on the human. In principle, cocktails “without alcohol” do not contain any ethanol. From a chemical aspect, however, both ethanol and glycerin are alcohols. If a colloquially called “cocktail with alcohol” is to now be bottled in the vessel, provision can be made to only add ethanol to the beverage liquid. If, in contrast, a colloquially called “cocktail without alcohol” is to be bottled in the beverage container, glycerin can be added, which has no intoxicating effect on the human. Glycerin can be found in many foods and is harmless. Beverages, for example cocktails, with and without alcohol and containing one or more ice moldings can thus be produced by means of the described method.

If initially one ice molding and then beverage liquid are added into the beverage container at a temperature of ≤0° C., the ice moldings can adhere to the bottom of the vessel and do not swim to the top, when the beverage liquid is added. In response to adding the ice molding into the beverage container, said ice molding drops to the bottom of the vessel and touches it. On principle, the bottom of the beverage container has a higher temperature than 0° C., for example room temperature, and thus slightly melts the ice molding on the outside. The ice molding has a melting temperature of approximately 0° C. In response to the melting on the surface, a water film is created between ice molding and warmer bottom. Only then is liquid beverage liquid added into the beverage container at a temperature of <0° C. In spite of its temperature of colder than 0° C., the water-based beverage liquid is liquid, because the alcohol content lowers the freezing point of the beverage liquid. The freezing point is for example −7° C. The cold liquid freezes the water film created beforehand between ice molding and vessel bottom as well as the surface of the melted ice molding again. The ice molding hereby forms a connection with the vessel bottom, so that said ice molding adheres thereto.

The beverage container and thus the bottled beverage can then be held at a temperature between the freezing point of the beverage liquid and the freezing point of the ice molding, thus for example at a temperature between 0 and −7° C. The beverage liquid remains liquid and ready to drink; the ice molding remains frozen and adheres tightly to the vessel bottom.

If, in contrast, beverage liquid is initially added into the beverage container at a temperature of ≤0° C., and at least one ice molding is then introduced in the beverage container, the ice moldings do not adhere to one another and also not to the vessel bottom, but swim freely in the beverage liquid. The beverage liquid added into the beverage container can also have a temperature of below 0° C. above its own freezing point here. The water ice moldings are then added into a liquid, which is colder than their own freezing point. The surface of the ice moldings is not melted. The ice molding remains completely frozen and a water film can also not form on its surface. As a result, the ice molding does not have an opportunity to connect indirectly or directly to another ice molding or to the wall or to the bottom, respectively, of the beverage container via a water film. Every added ice molding can remain separate inside the beverage liquid and swims freely therein. In the case of this alternative embodiment, the freezing point difference is significant as well in order to effectively avoid adhesions. After the closing of the beverage container, the beverage container and thus the bottled beverage can be held at a temperature between the freezing point of the beverage liquid and the freezing point of the ice molding. The beverage liquid then remains liquid and ready to drink. The ice moldings thus remain solid in the frozen state.

It is also possible to fill in the liquid beverage liquid at a temperature of above 0° C., the freezing point of the water ice. If, for example, up to 30% of the ice cubes melt until the cool-down of the liquid beverage liquid to less than or equal to 0° C., this is still acceptable. This liquid, which is converted into water, then dilutes the liquid beverage liquid, which, however, can be bottled beforehand at a corresponding higher concentration.

Prior to the filling, the empty beverage container can initially be cooled to a temperature T between the freezing point G of the beverage liquid and 0° C. If the beverage liquid is added into the beverage container first, it cannot initially heat to above 0° C., possibly through the vessel wall, which is to be avoided at the point the ice molding is added, so that the latter does not melt. In response to adding the ice molding, the beverage liquid has to have a temperature of below or equal to 0° C. This can in particular be avoided in a supporting manner in that the empty vessel prior to filling with the beverage liquid is initially cooled to a temperature T between the freezing point G of the beverage liquid and 0° C., in other words thus below the freezing point of water.

The beverage container can also be cooled to colder than freezing point G. The beverage liquid then also freezes at the vessel wall. Maximally as much liquid can freeze, as the bottle can remove energy from the beverage liquid as a result of its specific thermal capacity. If, in contrast, the ice molding is added into the beverage container first, said ice molding falls onto a vessel bottom, which is colder than 0° C.

When adding the ice moldings, an amount of liquid water can be added at a temperature of T>0° C., which covers the bottom the beverage container. In combination with a vessel bottom, which has cooled down below the freezing point of the ice molding to below 0° C., a quick reliable option for connecting the ice molding to the bottom of the beverage container is established. The cold vessel bottom allows for the added water to freeze thereon and also freezes the added ice moldings thereto. As a result, the ice moldings are indirectly connected firmly to the vessel bottom via the added frozen water layer.

Prior to adding the liquid beverage liquid, the beverage container, which is filled with at least one ice molding, can initially be cooled to a temperature T between the freezing point G of the beverage liquid and 0° C. The connection between ice moldings and vessel dilutes and stabilizes by means of this cooling to a temperature between the two freezing points. The connection cools and gains firmness. The beverage liquid is then only added to this firm connection.

The beverage container, which is filled with ice moldings and beverage liquid and which is closed, can be cooled to a temperature below the melting points of the ice moldings (0° C.) and of the beverage liquid (G). Later, in particular shortly prior to the provision for consumption, the beverage container can be heated to a temperature T between the freezing point G of the beverage liquid and 0° C.

For a longer shelf life or for parts of the transport route, the beverage can be frozen solid to temperatures below the freezing point G of the beverage liquid. In this solidly frozen state, both beverage liquid and ice moldings are in the frozen solid state. Later, for example at the location shortly before being provided for consumption, the beverage can be stored at a storage temperature between the two freezing points G of the beverage liquid and 0° C. The beverage liquid then melts again and becomes liquid. After some time, the temperature of the beverage liquid will then be between the freezing point G and 0° C. At this temperature below 0° C., the freezing point of the ice moldings, the ice moldings, however, remain in the frozen state and are also perceived as such when being served. Both the beverage comprising ice moldings, which are frozen to the bottom, and the beverage comprising swimming ice moldings, are suitable for the complete freezing.

In the case of the method for producing a beverage in a beverage container in the embodiment described herein or in the case of other embodiments, an apparatus for inserting at least one ice molding in the beverage container, in particular in the case of the embodiment of the beverage container with tapering container opening, can be used, which has at least one guide device for the ice moldings comprising an end-side outlet and a positioning device, which orients the outlet of the guide device and the container opening relative to one another. An apparatus for inserting at least one ice molding is thus created, which, in its alternative embodiments, can be used for filling in different method designs. In one embodiment, an arrangement comprising a beverage container and an assigned apparatus for inserting at least one ice molding in the one beverage container is created.

The positioning device can have a funnel, which can accommodate the container opening and can secure it in a defined position. A vibration device can be provided on the guide device and/or on the positioning device. The guide device can be shaped as ice-making device of the through flow cooler principle and can have a separating device comprising at least one shearing element, wherein the shearing element is guided at the outlet of the ice-making device. The shearing element can be guided directly abutting on the outlet of the ice-making device. Depending on the wait time before the next ice molding is deflected from the exiting strand of ice, the length of the ice molding can be varied. The separation of an ice molding from the strand of ice is carried out by the separating device. For this purpose, the separating device has the shearing element, which is guided on the outlet of the separating device. The shearing element is embodied to shear off the strand of ice—is thus shaped to be correspondingly pointed or sharp-edged, respectively. When the shearing element is guided on the outlet of the separating device, it can thus be ensured that the position and orientation of the separated ice molding is hardly impacted by shearing forces and that the ice molding hardly cants when being inserted into the container opening.

The guide device can be embodied as ice-making device with the through flow cooler principle and can have a separating device comprising at least one shearing element, wherein the shearing element is guided on the container opening. The ice molding can be sheared off from the strand of ice in this case in the vicinity of the container opening, after it has already been inserted slightly into the container opening. The ice molding inserted into the container opening is already guided by the wall of the container opening and is highly unlikely to cant when being sheared off just above the container opening.

The shearing element can be guided at the height of a predetermined breaking point on the strand of ice exiting the ice-making device. Provision can be made for a second shearing element located opposite the first shearing element.

The ice-making device can have a cooling cylinder, in which a strand of ice is produced, wherein the cooling cylinder has an inlet for filing with water and an outlet for discharging the strand of ice. A defined feed of the strand of ice through the cooling cylinder can be ensured on the one hand by means of such an ice-making device, and the exiting strand of ice is guided with regard to its direction and exit speed on the other hand. The outlet of the cooling cylinder can be positioned relative to the container opening, in order to center the exiting strand of ice, for example with the container opening.

The guide device can be embodied as a magazine comprising a plurality of separated or divided ice molding chambers. Such a magazine can for example have a plurality of ice molding chambers, which are separated from one another and in which individual ice moldings were frozen. Each ice molding chamber then includes a frozen formed ice molding. An ice molding is guided in its chamber.

A shearing off on the predetermined breaking point can provide for a substantially flat breaking or shearing surface. A flat breaking surface provides the following ice molding, which is inserted next into the container opening, with a smaller contact surface and thus also reduces the likelihood of canting of the following ice molding. The following ice molding cannot catch on the first ice molding.

The guide device can have a chute, wherein an ice molding can slide along on the inclined chute to the container opening. In the case of such an embodiment, individual ice moldings can be conveyed onto the chute on the inlet side, they are then guided in a defined direction on the chute at a defined speed and, on the outlet side of the chute, have a defined impulse, which corresponds to the positioning of the container opening in such a way that the ice molding can be freely inserted into the container opening, without canting at that location. In other words, the chute thus ensures in a preparatory manner that the ice molding is guided in a direction, in which it likely does not cant inside the container opening.

The guide device can have a funnel, wherein an ice molding in the funnel is guided towards the container opening. A funnel makes it possible to catch a bottle neck and to center the latter along its conically tapering walls on the funnel outlet in a defined manner, when the bottle is pushed into the funnel. After being pushed into the funnel, each bottle has the same position relative to the funnel outlet. In the case of this embodiment, the funnel can have the function, as described with regard to the chute, of orienting the ice molding with regard to its direction of movement and speed of movement, so that it can slide freely into the container opening. By using a funnel, this can be realized in that the funnel outlet is arranged above or even partially inside the container opening.

A reliable insertion into the container opening without canting of the ice molding can be attained by means of the apparatus for inserting at least one ice molding into beverage containers comprising tapering container opening. On principle, the embodiment of the ice molding is arbitrary. On the one hand, they can be ice cubes, but, on the other hand, they can often also be cylindrical elongated ice moldings. The length of these cylindrical ice moldings can vary thereby. The ice is made for example on the basis of water.

One or more of these ice moldings are inserted into the beverage container through the tapered container opening. The beverage container can for example be a bottle or a jar, such as yoghurt jars or pickle jars, which are suitable to accommodate beverage liquids colder than 0° C.

The guide device for the ice molding in particular serves the purpose of guiding the water ice molding in the direction towards the tapered container opening outside of the beverage container in such a way that the ice molding can be inserted into the container opening without canting. In one embodiment, the guide device has an end-side outlet. The ice molding exits from the guide device at this outlet, namely in defined position and with defined impulse—thus direction and speed component. In other words, the guide device will ensure that the ice molding is discharged in such a way at its end-side outlet that it falls at a defined speed in a defined direction. In connection with the positioning device, a canting-free insertion of the ice molding into the tapered container opening can thus be ensured. The positioning device can create a relative positioning between the outlet of the guide device and the container opening, in that the guide device and/or the container opening are moved towards one another until they stand centrically in front of one another, for example.

A vibration device can set the guide device or the outlet thereof or the positioning device, respectively, into vibration. Should an ice molding cant in response to being inserted into the tapered container opening, it can be freed by being shaken by means of the vibrations from the vibration device via the guide device and/or the positioning device by means of the vibrations and then does still move into the container opening, without requiring a manual engagement by the operator.

After the ice-making device has been oriented as guide device by means of the positioning device with the container opening, the strand of ice exiting from the ice-making device moves slowly into the container opening. At the time the ice molding is sheared off from the strand of ice, the ice molding is thus already located slightly inside the tapered container opening and has a certain stability against canting as a result of the contact with the wall of the container opening. By guiding the shearing element on the outlet of the ice-making device, a shearing force, which acts on the separated ice molding, can be reduced.

### DESCRIPTION OF EXEMPLARY EMBODIMENTS

Further exemplary embodiments will be described in more detail below with reference to figures of a drawing:

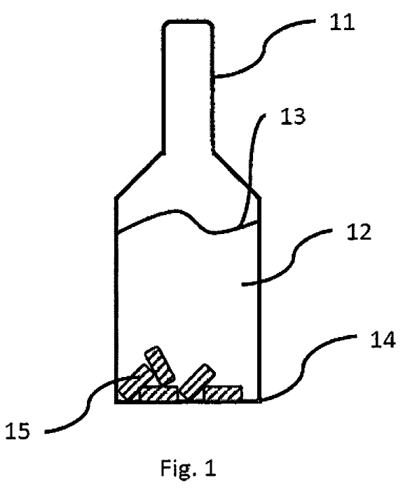

FIG. 1 shows a bottled beverage comprising ice moldings, which firmly adhere to the vessel bottom;

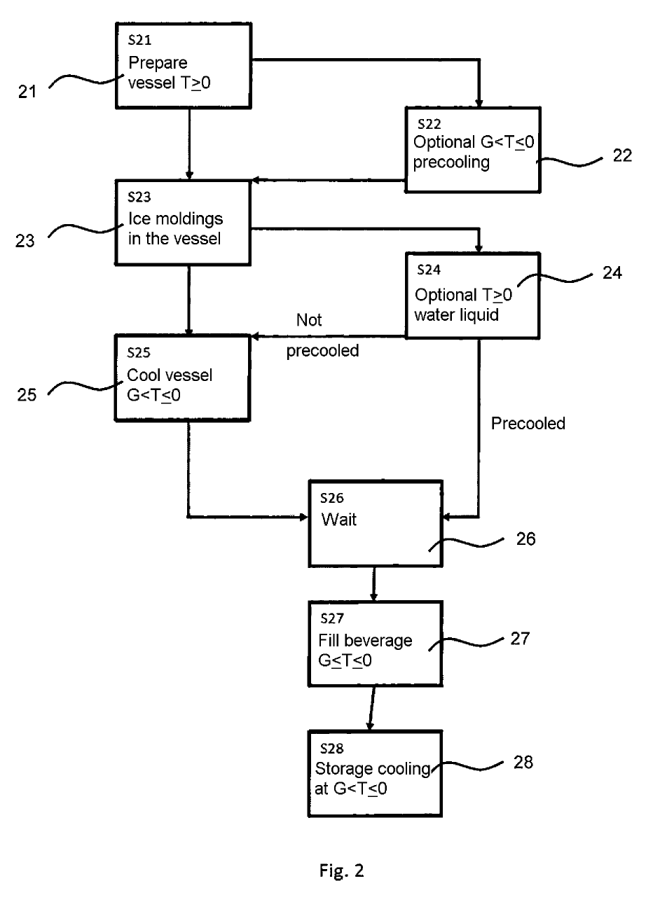

FIG. 2 shows the method for adhering the ice moldings to the vessel bottom;

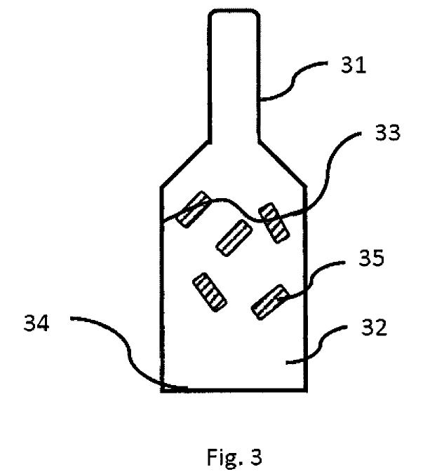

FIG. 3 shows a bottled beverage comprising the freely swimming ice moldings;

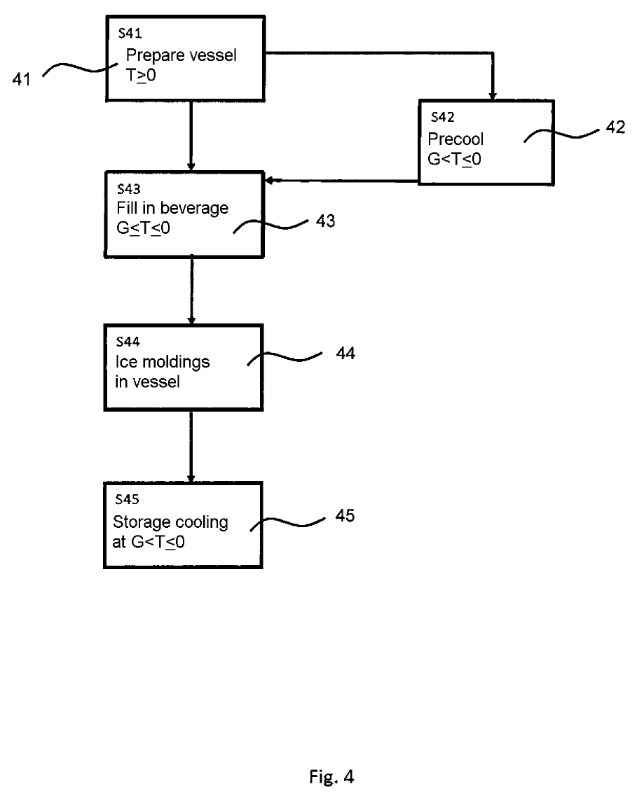

FIG. 4 shows the method for introducing the ice moldings in a freely swimming manner;

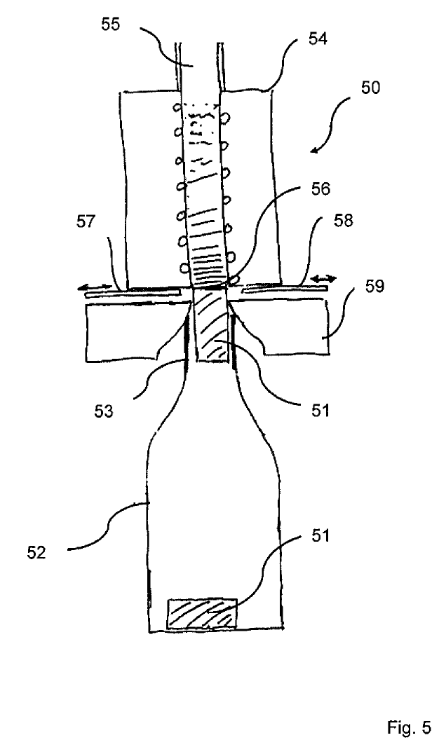

FIG. 5 shows a schematic illustration of an apparatus for introducing water ice moldings in a beverage container comprising an ice making device of the through flow cooler principle in cross section;

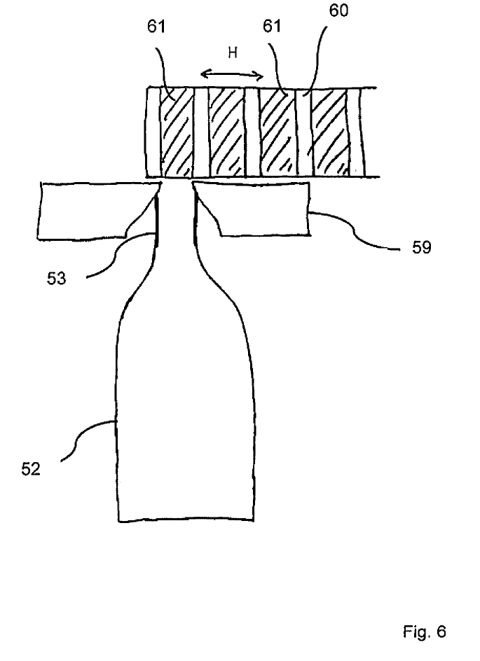

FIG. 6 shows a schematic illustration of a further apparatus for introducing water ice moldings in a beverage container comprising linearly shiftable magazine comprising a plurality of ice molding chambers in cross section;

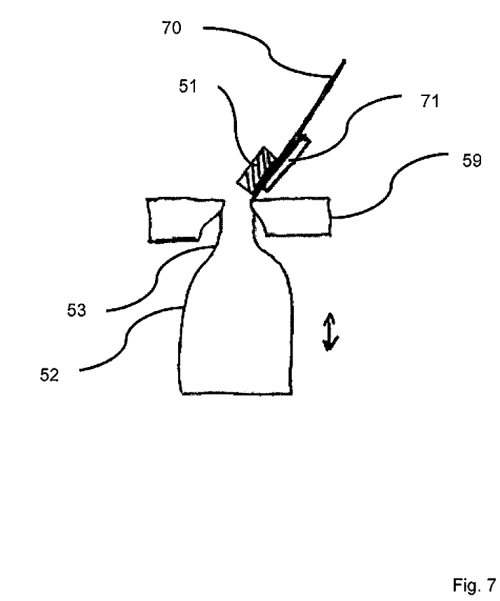

FIG. 7 shows a schematic illustration of another apparatus for introducing water ice moldings in a beverage container comprising an inclined chute in cross section, and

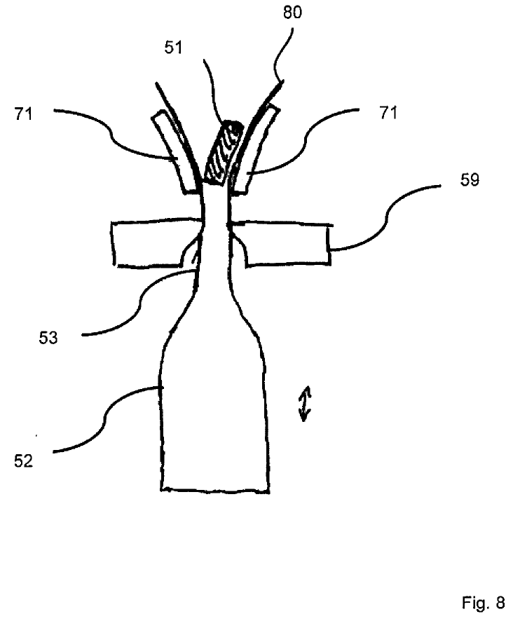

FIG. 8 shows a schematic illustration of yet a further apparatus for introducing water ice moldings in a beverage container comprising funnel in cross section.

FIG. 1 shows a beverage container or vessel 11, which is embodied here as closable bottle to transport the beverage. The liquid alcoholic or non-alcoholic beverage liquid 12, which is filled into the beverage container 11 up to the fill level 13, is located in the beverage container 11.

Ice moldings 15, which, as a result of the production using water, can also be identified as water ice moldings, adhere to the vessel or container bottom 14. The ice moldings 15 are embodied as cylindrical ice cubes here, which fit through the bottle neck. The ice moldings 15 do not only adhere to the vessel bottom 14, but also to one another. In other words, a solid ice clump formation is thus created on the vessel bottom 14, which adheres to the latter even if the beverage container 11 is turned upside down, for example.

FIG. 2 shows a schematic illustration for a method for producing a beverage according to FIG. 1. At first, the vessel to be filled is prepared in step 21. On principle, this takes place at temperatures of T≥0° C., in particular at room temperature.

Following this, ice moldings are introduced into the beverage container in step 23. Due to the fact that the ice moldings of water are frozen, they have a freezing point=melting point of 0° C. On their surface, they will melt as a result of the warmer vessel. A water film is created between ice moldings and vessel 11. In response to being filled in, the ice moldings can also already have a water film on their surface.

The beverage container is subsequently cooled to a temperature T between the freezing point G of the beverage liquid and 0° C. in step 25. The water film created beforehand freezes thereby and the ice moldings freeze to the vessel.

The threshold values of ranges in this application (here G and 0 degrees Celsius) can in each case be reached as well.

The beverage container 11 can also be cooled to be colder than the freezing point G. The beverage liquid then also freezes to the vessel wall. Maximally as much liquid can freeze as the bottle can remove energy from the beverage liquid as a result of its specific thermal capacity.

After a wait time in step 26, the beverage liquid is added into the beverage container in step 27. The temperature of the added beverage liquid lies between its freezing point G and 0° C.

As a result, this means that the beverage liquid continuously cools the ice moldings, which have a freezing point of 0° C., and keeps them frozen. The colder beverage liquid prevents that the ice moldings start to melt on their surface.

To attain the continuous cooling, the storage cooling is carried out at a temperature between or equal to the two freezing points in step 28.

An amount of liquid water, which covers the vessel bottom, is added at a temperature>0° C. in the optional step 24.

The point in time of the water addition is close to the addition of the ice moldings. The addition of the liquid amount of water can take place at the same time as the addition of the ice moldings, but it can also take place shortly before or shortly after it.

It is essential that the liquid amount of water is not frozen before the ice moldings are added. This is so, because the liquid amount of water then freezes the ice moldings virtually as binder to the vessel, when the entire unit is then cooled to a temperature of <0° C.

When the beverage container is first optionally precooled to a temperature T between the freezing point G of the beverage liquid and 0° C. in step 22, the liquid amount of water added in step 24 then freezes relatively quickly between ice moldings and vessel, without requiring a downstream cooling, as in step 25. However, this downstream cooling in step 25 can also still be carried out nonetheless.

The beverage container can also be cooled to be colder than the freezing point G. The beverage liquid then also freezes to the vessel wall. Maximally as much liquid can freeze, as the bottle can remove energy from the beverage liquid as a result of its specific thermal capacity.

If the precooling took place in step 22, however, one can skip directly from step 24 to step 26, the waiting step.

FIG. 3 shows a bottled beverage comprising two ice moldings swimming therein. The beverage container 31 is embodied in a closable manner, for example as bottle, which is suitable to be transported. The liquid beverage liquid 32 is located in the vessel 31 up to the status level 33. The ice moldings 35 swim freely in the liquid beverage liquid 32 here. The ice moldings 35 are not connected to the vessel bottom and they are also not frozen to one another. The ice moldings 35 swim completely freely in the beverage liquid 32.

FIG. 4 shows a schematic illustration for a method for producing a beverage according to FIG. 3.

At first, the beverage container is prepared to be filled at a temperature T≥0° C. in step 41. On principle, the bottling takes place at room temperature. In step 42, the beverage container can optionally be precooled to a temperature between the freezing point G of the beverage liquid and 0° C. in step 42.

The beverage container 31 can also be cooled to be colder than freezing point G. The beverage liquid then also freezes to the vessel wall. Maximally as much liquid can freeze, as the bottle can remove energy from the beverage liquid as a result of its specific thermal capacity. This, however, is optional. One can also skip directly from step 41 to step 43. The beverage liquid is filled in at a temperature T between its freezing point G and 0° C. in step 43.

In step 44, the ice moldings are then added into the beverage container, in which the beverage liquid is already located at a temperature of ≤0° C. (freezing point of the ice moldings).

To ensure a continuous cooling to secure the cold conditions, the storage cooling is carried out at a temperature between or equal to the two freezing points in step 45.

Depending on the cold conditions, it may be expedient to insert the optional precooling step 42, so as to avoid that the beverage liquid is heated to a temperature of >0° C. by means of the room temperature-warm vessel. This should be avoided, if possible, so as to avoid a melting of the ice moldings on their surface. The beverage liquid with its temperature colder than 0° C., which is already located in the vessel at the time the ice moldings are added, effectively prevents that the ice moldings melt on the surface. They thus do not have the opportunity to freeze to one another or to the vessel wall. As a result, the ice moldings remain separated so as to swim freely separated from one another inside the beverage liquid in the case of this alternative embodiment.

FIG. 5 shows a schematic illustration of an apparatus 50 for introducing water ice moldings 51 into a beverage container 52 comprising a tapering container opening 53. An ice-making device of the through flow cooler principle 54 serves as guide device for the water ice moldings 51. Liquid water is introduced at the inlet 55 of the ice-making device 54 and is cooled to a temperature below the freezing point inside the ice-making device 54, so that a strand of ice exits at the outlet 56. The ice molding 2 is separated from the strand of ice here.

The separation of the ice molding 51 from the strand of ice takes place by means of two opposite shearing elements 57, 58, which separate the ice molding 51 from the strand of ice on both sides. The shearing elements 57, 58 move perpendicular to the strand of ice in the arrow direction and exert a perpendicular separating force in the radial direction thereon. They virtually act like pliers and squeeze the strand of ice through. As a result of the arrangement of the shearing elements 57, 58 opposite one another, a halfway flat breaking surface is created between the two pressure points. This provides the above-described canting protection.

The guide device in the form of the ice-making device here is connected to a positioning device 59. The positioning device 59 is illustrated in cross section here and is embodied as funnel. In the interior, it has a funnel head, which is open in the direction of the beverage container 52, which is to be filled. In response to the filling, the beverage container 52, here in the form of a bottle, is pushed against the positioning device 59 from below in this example, wherein the tapered container opening 53, here in the form of the bottle neck, is pushed into the funnel head of the positioning device 59 from below, and the axis of the tapered container opening 53 is thus centered with the funnel axis.

Due to the fact that the outlet 56 of the ice-making device 54 is also arranged so as to be centered to the funnel axis of the positioning device 59, the axis of the outlet 56 of the ice-making device 54 is thus centered with the axis of the tapered container opening 53, whereby the positioning device 59 fulfills the task of orienting the outlet 55 of the ice-making device 54 and the tapered container opening 53 relative to one another. As a result, the strand of ice, which exits from the outlet 56 of the ice-making deice 54, then moves exactly into the tapered container opening 53, without experiencing any kind of inclined shearing force and to thus cant. The shearing elements 57, 58 shear the ice molding 51 off the strand of ice, and the ice molding can then drop freely into the beverage container 52. The tapered container opening 53 is then free for the next ice molding again.

FIG. 6 shows a schematic illustration of a further apparatus for introducing water ice moldings 51 in a beverage container 52, in the case of which the guide device is embodied with a magazine 60 comprising a plurality of separated ice molding chambers 61. Frozen ice moldings, which can be conveyed out of the ice molding chambers 61 by means of an ejection mechanism, are located inside the ice molding chambers 61.

So that the ice moldings 51 can slide into the tapered container opening 53 without canting, the positioning device 59, here in the form of a funnel, ensures the orientation of the tapered container opening 53 to the ice molding chamber 61, out of which an ice molding is to be conveyed and is to be conveyed into the beverage container 52.

The funnel-shaped positioning device 59 can position the tapered container opening 53, here in the form of a bottle neck as described above, for this purpose. The magazine 60 comprising the ice molding chambers 61 is then positioned relative to the positioning device 59 in such a way that the axis of an ice molding chamber corresponds to the axis of the funnel of the positioning device 59 or with the tapered container opening 53, respectively. If the ice molding is then conveyed out of the centered ice molding chamber 61, it can slide into the tapered container opening 53 without canting.

The magazine 60 is then shifted horizontally along the arrow direction H until the next adjacent ice molding chamber 61 with its central axis corresponds to the central axis of the tapered container opening 53 again. The ice molding, which is located in this ice molding chamber 61, which is now centered, can be inserted into the beverage container 52, which is still positioned below the positioning device 59, on the one hand. On the other hand, however, the beverage container 52, which is positioned below the positioning device 59, can be exchanged in the meantime, and the ice molding, which is located in the ice molding chamber 61, is then inserted into a new beverage container area 52.

The magazine 60 is then moved further by one ice molding chamber 61 along the arrow direction H, until the central axis of the next ice molding chamber 61 is centered relative to the central axis of the tapered container opening 53. The individual ice molding chambers 61 are combined by means of a magazine 60 in this exemplary embodiment, and are guided past the positioning device 10 or past the container opening 53, respectively. The guiding of the individual ice molding chambers 61 past the container opening 53, however, can also take place for example by means of an endless chain, to which individual ice molding chambers are fastened.

Instead of the shown matrix-like magazine 11, a circular revolver can also be used, for example. Said revolver would then not be oriented in a translatory manner, like the magazine 11, but would have to experience a rotatory orientation.

FIG. 7 shows a schematic illustration of another apparatus for introducing water ice moldings 51 in a beverage container 52, wherein the guide device is formed with a chute 70. The chute 70 is connected to the funnel-shaped positioning device 59. The funnel-shaped positioning device 59 can position the tapered container opening 53 of the beverage container 52, as described above. The chute 70, which is connected to the funnel-shaped positioning device 59, ensures that an ice molding 51, which is located on the chute 70, receives a defined direction of movement and speed of movement. The connection of chute 70 and positioning device 59 is embodied in such a way that the outlet of the chute 70 leads into the funnel of the positioning device 59, so that an ice molding 51, which slides down the chute 70, slides into the funnel-shaped recess of the positioning device 59 at the outlet of the chute 70.

This has the result that the ice molding 51 can then be inserted into the tapered container opening 53, which is positioned therebelow. Due to the fact that the chute 70 located thereabove has already caused a defined direction of movement and speed of movement on the ice molding 51, the ice molding slides into the tapered container opening 53 without canting and through the latter into the beverage container 52.

A vibration device 71, which can set the chute 70 into vibrations, is arranged on the chute 70. The vibrations of the chute 70, in turn, are further transferred to an ice molding 51, which is located on the chute 70. The vibrations have the advantage that an adhering of the ice moldings 51 to the chute 70 can be reduced, and should the ice molding 51 nonetheless cant in response to being introduced into the tapered container opening 53, this canting is released.

FIG. 8 shows a schematic illustration of yet a further apparatus for introducing water ice moldings 51 in a beverage container 52, wherein the guide device has a funnel 80. The funnel 80 is fastened to the positioning device 59 by means of its tapered funnel outlet in such a way that the central axis of the tapered funnel outlet of the funnel 80 corresponds to the central axis of the funnel-shaped recess of the positioning device 59, and thus also corresponds to the central axis of the tapered container opening 54, which is pushed into the positioning device 59 from below.

An ice molding 51, which is placed into the funnel 80, is diverted in a defined direction of movement at defined speed of movement by means of the funnel 80. The ice molding 51 will be oriented in such a way that it will slide perpendicularly through the outlet of the funnel 80.

Due to the described arrangement of the funnel 80, the ice molding 51 is then in a state of movement, in which it can slide freely and without canting into the tapered container opening 53. A vibration device 71, which can set the funnel 80 into vibrations, is arranged around the funnel 80 (illustrated in cross section here). These vibrations are further transferred to an ice molding located adjacently in the funnel 80 and can, as described above, reduce adhesive forces of the ice molding 51 or can release a canting in the outlet of the funnel 80, respectively, or in the tapered container opening 53, respectively.

The features disclosed in the above description, the claims as well as the drawings, can be relevant for the realization of the various embodiments, both alone and in any combination.

### LIST OF REFERENCE NUMERALS

11, 31, 52 beverage container
12, 32 liquid beverage liquid
13, 33 fill level
14, 34 bottom
15, 35, 51 ice molding
50 apparatus
53 tapered container opening
54 ice-making device of the through flow cooler principle
55 inlet
56 outlet
57, 58 shearing elements
59 positioning device
60 magazine
61 ice molding chamber
70 chute
71 vibration device
80 funnel

1. A method for producing a beverage in a beverage container, comprising the following steps:
providing a beverage container, which is to be filled;
introducing a cooling agent in the beverage container through a container opening, wherein the cooling agent comprises at least one water ice molding;
filling the beverage container with a beverage liquid through the container opening;
closing the container opening by means of a disposable closure and
cooled storing of the filled beverage container;
wherein
the beverage container comprises a container section which tapers towards the container opening and which is closed by means of a disposable closure;
the cooling agent comprising the at least one water ice molding and the beverage liquid are introduced through the tapering container section after passing the container opening, and
the at least one water ice molding in one spatial dimension is larger than a diameter of the container opening.

2. The method according to claim 1, wherein the cooling agent comprising the at least one water ice molding is introduced during and/or after the filling of the beverage container with the beverage liquid.

3. The method according to claim 1, wherein the filled beverage container is stored at a cooling temperature, which is higher than the freezing point of the beverage liquid.

4. The method according to claim 1, wherein the container opening is closed by means of a disposable closure from the following group: crown cork, cork, screw closure, twist-off closure, clip closure, and hot sealing closures.

5. (canceled)

6. (canceled)

7. The method according to claim 1, wherein an alcoholic beverage liquid, which includes a percentage of ethanol, and/or a non-alcoholic beverage liquid, which includes a percentage of glycerin, are filled in.

8. The method according to claim 1, wherein prior to introducing the cooling agent and/or prior to filling with the beverage liquid, the beverage container is cooled to a temperature between the freezing point of the beverage liquid and 0 degrees Celsius.

9. The method according to claim 1, wherein when introducing the cooling agent comprising the at least one water ice molding, an amount of liquid water, which covers the one vessel bottom of the beverage container, is additionally filled into the beverage container.

10. The method according to claim 1, wherein during the cooled storing, the filled beverage container is cooled to a cooling temperature, which is lower than a melting temperature of the beverage liquid.

11. The method according to claim 1, wherein the at least one water ice molding is supplied to the container opening via a guide device, wherein the guide device is positioned relative to the container opening by means of a positioning device.

12. A device for producing a beverage in a beverage container, wherein the device is set up to:
provide a beverage container, which is to be filled, which has a container section, which tapers towards a container opening;
introduce a cooling agent in the beverage container through the container opening via an inserting apparatus, wherein the cooling agent comprises at least one water ice molding and wherein the inserting apparatus is formed with a guide device and a positioning device, by means of which an outlet of the guide device is positioned relative to the container opening;
fill the beverage container with a beverage liquid through the container opening, and
close the container opening by means of a disposable closure;
wherein the apparatus is further set up to introduce the cooling agent comprising the at least one water ice molding and the beverage liquid through the tapering container section after passing the container opening, wherein the at least one water ice molding in one spatial dimension is larger than a diameter of the container opening.

13. A beverage article comprising a beverage, comprising a beverage container, which comprises a container section, which tapers towards a container opening;
a beverage liquid, with which the beverage container is filled;
a cooling agent, which comprises at least one water ice molding and is accommodated in the beverage liquid, and
a disposable closure, by means of which the container opening of the beverage container is closed, and through which the cooling agent comprising the at least one water ice molding and the beverage liquid are introduced in the beverage container;
wherein the at least one water ice molding in one spatial dimension is larger than a diameter of the container opening.
